(19) United States
(12) Patent Application Publication
(10) Pub. No.: US 2009/0017341 A1
(43) Pub. Date: Jan. 15, 2009

(54) Air electrode composition for intermediate temperature electrochemical devices

(75) Inventors: Brian J. Ingram, Chicago, IL (US); Michael Krumpelt, Naperville, IL (US); Terry A. Cruse, Lisle, IL (US)

Correspondence Address: FOLEY & LARDNER LLP, 321 NORTH CLARK STREET, SUITE 2800, CHICAGO, IL, 60610-4764, US

(73) Assignee: UChicago Argonne, LLC

(21) Appl. No.: 11/825,815

(22) Filed: Jul. 9, 2007

(51) Int. Cl. H01M 4/86; H01B 1/02

(52) U.S. Cl. 429/13; 252/519.12

(57) ABSTRACT

A composition of matter and method of use of an electrode for intermediate temperature electrochemical devices. An electrode consists essentially of a perovskite based oxide having a composition of La₁₋ₓSr₁₋ₓMn_{1-y}Cr_{y}O_{3-δ} and the electrode can be used at intermediate operating temperatures of 650-800° C.

The United States Government certain rights in this invention pursuant to Contract No. W-31-109-ENG-38 between the United States Government and The University of Chicago and/or pursuant to Contract No. DE-AC02-06CH11357 between the United States Government and UChicago Argonne, LLC representing Argonne National Laboratory.

This invention is directed to electrodes for electrochemical devices or fuel cells. More particularly the invention is directed to air electrode compositions for intermediate temperature fuel cells. Such compositions include, for example, chromium doped lanthanum strontium manganite (“LSM” hereinafter) and like varieties of perovskite-based oxides of the form ABO₃.

### BACKGROUND OF THE INVENTION

Fuel cells have become more important for a variety of commercial purposes. Electrodes in solid oxide fuel cells are typically constructed of perovskite-based oxides of the general composition ABO₃. Typically the A-cation is lanthanum and doped with 15-25% alkaline earth metals, such as Sr or Ca, which contributes increased electronic carriers to improve perovskite electrical conductivity. The B-cation typically comprises a transition metal, such as Co, Mn, or Fe, which are adjusted in composition to achieve improved physical, chemical and electrical properties of the perovskite composition. In spite of many years of research and development, the electrical performance of the ABO₃ composition is limited by lack of adequate ionic conductivity. One attempt to alleviate this deficiency has been to add the ionic conductor yttrium stabilized zirconia (YSZ), and these composites typically operate at 1000 C. However, in order to establish practical commercial devices for consumer applications, the electrochemical cell should perform adequately at lower temperatures, such as in the intermediate temperature range of 650-800° C. Consequently, a need exists to develop another class of compositions based on the perovskite structure other than the standard YSZ/ABO₃ compositions in order to construct fuel cells which can be operated in the 650-800 C intermediate temperature range.

### SUMMARY OF THE INVENTION

The compositions of matter described herein are directed in part to providing high performance electrode materials at intermediate operating temperatures, particularly for the air electrode of an electrochemical fuel cell. Typically the air electrode exhibits the largest individual contribution to ohmic resistance of an electrochemical cell. Generally the activation overpotential, which is dictated by the oxygen exchange rate or catalytic behavior of the electrode, increases with decreasing temperature. In order to meet the strong need for electrochemical cells which operate at intermediate temperatures a new class of doped strontium lanthanum manganite has been developed. Doping on the A-site has been extensively studied and optimized, in which a low valent (<3+) cation is substituted on the A-site. It is less obvious, however, to include isovalent or high valent (>3+) dopants on the B-site. These dopants include most preferably chromium of selected compositional amounts and also include, Ga, Al, In, Fe, or V. For example, the composition La_{0.8}Sr_{0.2}Mn_{0.83}Cr_{0.17}O₃ has demonstrated an order of magnitude increase of electrode area specific resistance over conventionally used strontium-doped lanthanum manganite.

These and other objects, advantages and features of the invention, together with the organization and manner of operation thereof, will become apparent from the following detailed description when taken in conjunction with the accompanying drawings.

### BRIEF DESCRIPTION OF THE DRAWINGS

FIG. 1 illustrates a solid oxide fuel cell operation;

FIG. 2 illustrates unit cell volume of LSM-LSC as a function of chromium content;

FIG. 3 illustrates prior art values of electrical resistivity of LSM-LSC normalized to electrical conductivity of pure LSM from four point probe measurements;

FIG. 4 illustrates area specific resistance of LSM-LSC electrodes at 800° C normalized to area specific resistance of pure LSM in symmetric half cell measurements;

FIG. 5 illustrates cell voltage and power density of fuel cells with LSM/YSZ or LSM-Cr/YSZ cathodes normalized to the results of LSM/YSZ; and

FIG. 6 illustrates a plot of the imaginary and real parts of impedance for different Mn and Cr content in chromium doped LSM.

### DETAILED DESCRIPTION OF PREFERRED EMBODIMENTS

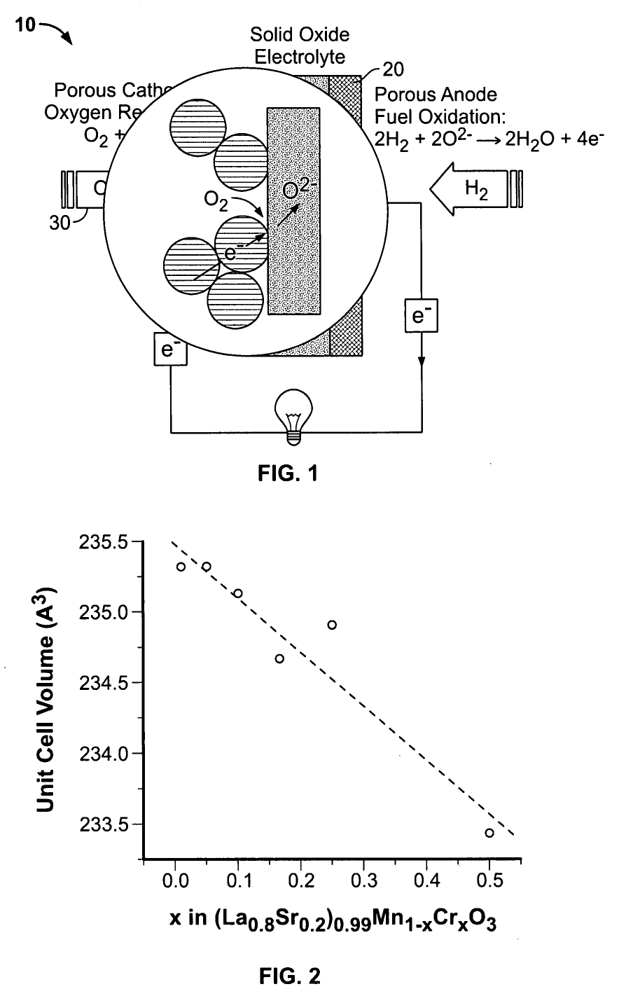

Operation of a typical electrochemical cell 10 is shown in FIG. 1 with a porous anode 20 where fuel oxidation occurs and with a porous cathode 30 where oxygen reduction occurs. Common cathodes 30 have included (La_{0.8}Sr_{0.2})MnO_{3-δ}, La_{0.8}Sr_{0.2}FeO_{3-δ}, and (La_{0.8}Sr_{0.2})Fe_{0.8}Co_{0.2}O_{3-δ}, but none of these materials operates suitably at intermediate temperatures. The instant invention is based on the flexibility of the ABO₃ perovskite structure to accommodate incorporation of mixed cations on a given site. For example, LSC (strontium doped lanthanum chromite, La₁₋ₓSr_{0.2}CrO₃), and LSM (strontium doped lanthanum manganite, La₁₋ₓSrₓMnO₃), are known to form a complete solid solution of the form La₁₋ₓSrₓMn_{1-y}Cr_{y}O₃. The phase purity and solid solution were verified using Vegard's law technique (i.e., a linear change in lattice parameter with atomic substitution) as shown in FIG. 2.

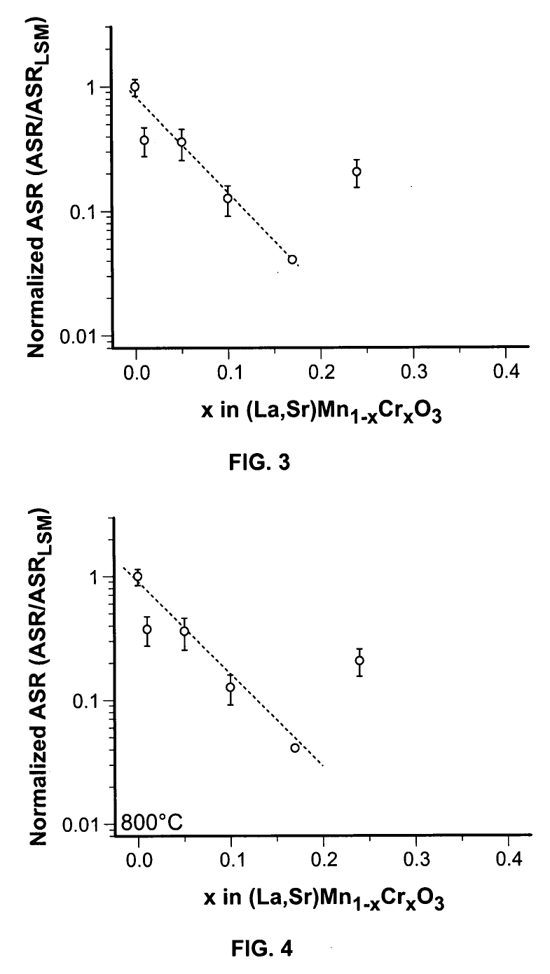

In FIG. 3 are shown prior art reported values of electrical conductivity for LSM-LSC (or LSMC) normalized to the electrical conductivity of pure LSM as determined by four point probe dc measurements. Clearly the substitution of Cr in LSM results in a significant decrease in electrical conductivity. It is also well established that LSC does not support oxygen vacancies due to the strong octahedral-site preference of chromium (III) species. Consequently, Cr substitution in LSM is predicted to limit the oxygen vacancies, thereby limiting oxygen exchange at the surface, and to reduce ionic conduction through the bulk as compared to LSM.

In a preferred embodiment of the invention the composition of the cathode 30 comprises a chromium doped LSM of general composition ABO₃ and more specifically, La₁₋ₓAₓB_{1-y}C_{y}O_{3-δ} where A is preferably Sr and/or Ca, B in preferably C, Mn and/or Fe and C is preferably Cr, Ga, Al, In, Fe, Zn and/or V. This composition with Cr doped LSM exhibits substantially improved electrochemical properties as shown in FIG. 4. This plot of area specific resistance (“ASR”) normalized to the ASR of pure LSM in symmetric half cell measurements shows dramatic relative improvement by virtue of Cr substitution. While not being optimized, the electrodes of FIG. 4 show an increase of nearly an order of magnitude in ASR with approximately a 17% Cr substitution over pure LSM. Chromium is completely soluble in the perovskite structure, however an optimized quantity is expected as LSC (La₁₋ₓSrₓCrO_{3-δ}) has a much lower electrical conductivity than LSM.

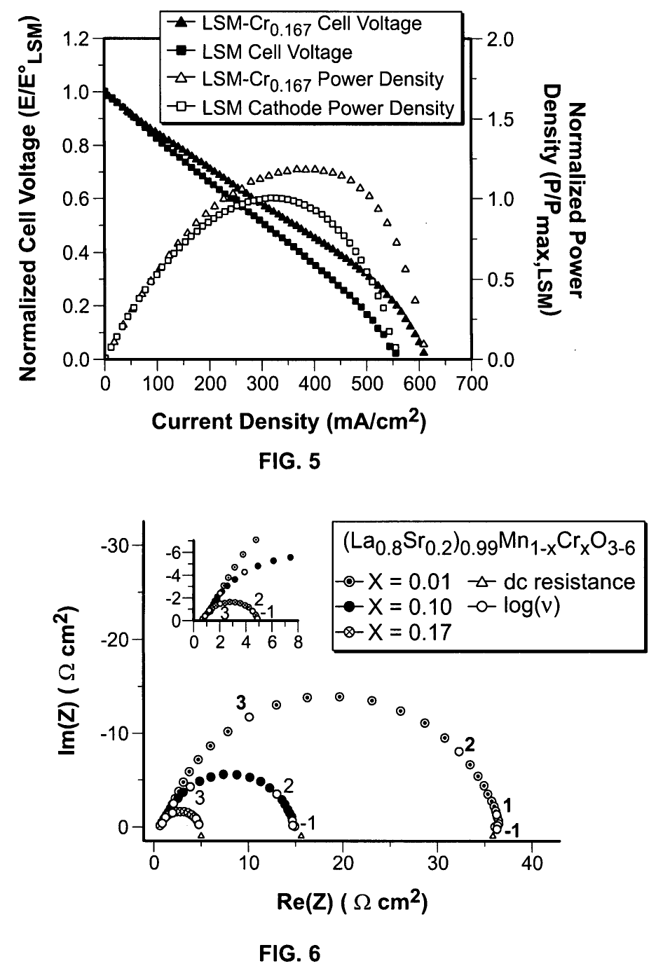

In FIG. 5 is shown the substantial improvement in maximum power density and cell voltage for a composite YSZ/LSMC cathode 30 in an anode supported oxide fuel cell 10 at standard operating current densities, about 250 mA/cm², as compared to the standard YSZ/LSM cathode 30.

Further, the impedance measurements of FIG. 6 were taken at 800° C. in air for symmetric half cells. These measurements were measured for various compositions of x=0.01, 0.10 and 0.17 in (La_{0.8}Sr_{0.2})Mn₁₋ₓCrₓO_{3-δ} Where S is less than about 0.005. The impedance is highly dependent on the stoichiometry of Cr and demonstrates the highly advantageous and surprising results for the use of Cr dopant in LSM.

In another aspect of the invention other components can be used rather than Cr, for example Ga, Al, In, Fe, Zn, or V, which results in a similar improvement as Cr for example for enhancing oxygen adsorption, exchange and conductivity resulting in greatly improved electrochemical cell performance. Further, in other embodiments the B-site (i.e., the Mn site) can be of fixed 3+ valence state which predominately prefers tetrahedral coordination, but has a different ionization potential than Mn³⁺ or possess a combination of these features.

The following non-limiting Example illustrates preparation of an electrochemical cell using on example of a Cr dopant.

### EXAMPLE

Appropriate molar amounts of constituent metal nitrate solutions are combined and ignited in a self combusting synthesis technique, for example, in the presence of glycine. The resultant fine grained perovskite-based oxide of the form (La₁₋ₓSrₓ)Mn_{1-y}Cr_{y}O₃, is intimately mixed with 0.5-1 micron 8YSZ (8% Y₂O₃ doped ZrO₂) in equal volume proportions. This composite mixture is screen printed on an 8YSZ electrolyte surface as part of an anode (Ni/8YSZ cermet) fuel cell. The entire structure is subsequently heated to 1250° C. for 1-2 hours. Performance results, for example FIG. 5, are collected between 650-800° C. at a constant applied current density of ˜250 mA/cm².

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments, and with various modifications, as are suited to the particular use contemplated.

What is claimed is:

1. An electrode composition for intermediate temperature electrochemical devices, comprising a perovskite based oxide electrode having a composition consisting essentially of La₁₋ₓAₓB_{1-y}C_{y}O_{3-□}.

2. The electrode composition as defined in claim 1 wherein the electrode comprises an anode.

3. The electrode composition as defined in claim 1 wherein the electrode comprises a cathode.

4. The electrode composition as defined in claim 1 wherein C is selected from the group consisting of Cr, Ga, Al, In, Fe, Zn and V.

5. The electrode composition as defined in claim 1 wherein x and □ are between about 0.01-0.25.

6. The electrode composition as defined in claim 1 where □ is less than about 0.005.

7. The electrode composition as defined in claim 1 further including a component of ZrO₂ doped with 8% Y₂O₃ combined by mixing with the La₁₋ₓAₓB_{1-y}C_{y}O_{3-□}.

8. The electrode composition as defined in claim I wherein both the cathode and the anode comprise a perovskite based oxide.

9. The electrode composition as defined in claim 1 wherein A is selected from the group of Sr and Ca.

10. The electrode composition as defined in claim I wherein B is selected from the group of Co, Mn, Fe and Ni.

11. The electrode composition as defined in claim 1 wherein y is about 0.01-0.25.

12. The electrode composition as defined in claim 1 wherein C is relected from the group consisting of Cr, Ga, Al, In, Fe, Zn and V and B is relected from the group consisting of Co, Mn, Fe and Ni.

13. A method of operating an electrochemical device, comprising the steps of:
providing a solid oxide fuel cell having a plurality of electrodes, at least one of the plurality of electrodes consisting essentially of strontium doped lanthanum magnetite doped with a component selected from the group of lanthanum chromite and lanthanum gallate;
elevating operating temperature to a range of about 650-800° C.; and
generating energy from the electrochemical device.

14. The method as defined in claim 13 wherein the strontium doped lanthanum magnetite comprises La₁₋ₓAₓMn_{1-y}Cr_{y}O_{3-□}.

15. The method as defined in claim 14 wherein x and y are between about 0.01-0.20.

16. The method as defined in claim 14 wherein A is selected from the group consisting of Sr and Ca.

17. The method as defined in claim 13 wherein Mn is replaced with at least one of Co, Fe and Ni.

18. The method as defined in claim 13 further including combining the La₁₋ₓAₓMn_{1-y}Cr_{y}O_{3-□} with a component of ZrO₂ doped with Y₂O₃.

19. The method as defined in claim 13 wherein the Cr_{y} is replaced by a component selected from the group consisting of Ga, Al, In, Fe, Zn and V.
